(19) United States
(12) Patent Application Publication
(10) Pub. No.: US 2004/0152056 A1
(43) Pub. Date: Aug. 5, 2004

(54) Method and apparatus for simulating a clinical trial

(76) Inventors: Cynthia Lee Lamb, Salem, CT (US); Jerry Coleman Lamb, Salem, CT (US); Armelde Pitre, Lisbon, CT (US)

Correspondence Address: Ryan, Mason & Lewis, LLP, Suite 205, 1300 Post Road, Fairfield, CT, 06430, US

(21) Appl. No.: 10/356,652

(22) Filed: Jan. 31, 2003

(51) Int. Cl. G06F 17/60; G09B 23/28

(52) U.S. Cl. 434/219; 434/262; 705/1

(57) ABSTRACT

A method and apparatus are provided for training and educating clinical data managers that perform various data related functions during clinical trials for pharmaceutical and other bioscience companies. The invention provides a clinical trial simulator using a combination of a simulated work environment, interactive multimedia, cohort teams, and specific clinical areas. A modular training process is optionally employed with each module covering a unique aspect of the drug development process. The simulated drug development process is thus tracked through a number of different modules. The modular approach allows the modular training process to progressively expose clinical data managers to various issues (through a simulated environment) that are encountered in a real clinical data environment. The skills and deliverables associated with each module can be assessed and corrected, if necessary, before proceeding to a subsequent module. In this manner, a defect introduced by a user in an earlier module will not prevent the successful completion of a subsequent module.

### FIELD OF THE INVENTION

The present invention relates to computer-based systems for training and educating clinical data managers that perform various data related functions during clinical trials for pharmaceutical and other bioscience companies, and more particular, the present invention relates to computer-based systems for training and educating clinical data managers using a combination of multimedia, laboratory simulations, and realistic clinical problems.

### BACKGROUND OF THE INVENTION

On average, a new drug does not reach the market for 12 years. Although drug companies spend an average of $200,000,000.00 to develop a new drug, only five in 5,000 compounds that enter preclinical testing even make it to human testing. In addition, only one of these five compounds that are tested in humans is ever approved by the Food and Drug Administration (FDA) in the United States. The drug development process is subject to various government regulations, for example, as specified in Title 21 of the Code of Federal Regulations (CFR) in the United States. Drug developers are required under federal law to demonstrate that a new drug is safe and effective, and to identify the optimal dosage. Clinical testing is performed to establish safety and efficacy in humans, dosages, label contents, and possible adverse side effects. Controlled clinical trials are the only legal basis for the FDA to conclude that a new drug has shown “substantial evidence of effectiveness,” as required by federal law.

The International Conference on Harmonization of Technical Requirements for Registration of Pharmaceuticals for Human Use, also referred to as “ICH,” developed guidelines specifying Good Clinical Practices (GCPs) that are closely tied to the development of today's regulatory environment. Good Clinical Practices cover all aspects of the design, conduct, analysis, and reporting of a clinical trial, and lay the groundwork for trial design. Good Clinical Practices identify all the key players in a clinical trial, as well as their roles, responsibilities, and required qualifications. Anyone involved in clinical trials needs a good working knowledge of Good Clinical Practices.

During the design, conduct, analysis and reporting phases of a clinical trial, several key documents and other “deliverables” are developed. This set of deliverables and documentation is necessary to prove to the investigators, sponsor (typically, the drug developer), regulatory authorities, and eventually, the public, that the new drug is safe and supports the claims contained on its label. The Protocol document is generally considered the single most important document developed for clinical trials. The Protocol is developed by the sponsor team during the planning stage and must be approved by the Institutional Review Board (IRB). The Protocol contains a complete specification of the research and treatment plans for the human subjects.

The Case Report Form (CRF) is an official working document for a drug trial that records the data on each human subject. Critical aspects of the Protocol must be understood before the CRF design can begin. CRFs typically consist of efficacy-related modules and safety-related modules, such as demographics, vital signs, physical examination and medical history of the human subjects. The CRF design should ensure that the right amount of data is collected, that all (and only) the data required by the protocol is collected, complexity and confusion are avoided and support the reporting requirements specified in the Protocol. The Data Management Plan is a planning document developed at the start of a study to clarify all data requirements, and describe the processes, roles, responsibilities, and schedule of events. The Data Management Plan is an important planning document for the clinical data managers.

Serious Adverse Events are any untoward medical occurrence that, at any dose, (i) results in death; (ii) is life-threatening; (iii) requires in-patient hospitalization or prolongation of existing hospitalization; (iv) results in persistent or significant disability or incapacity; or (v) is a congenital anomaly or birth defect. Serious Adverse Event forms are filled in by an investigator and all Serious Adverse Events have to be reported immediately by the sponsor to the FDA in the United States.

Thus, a clinical data manager must possess a lot of knowledge about the regulatory process, as well as the skills required to successfully design, collect, record and report the appropriate data for a clinical trial. Unfortunately, few, if any, comprehensive training tools exist to train and educate such clinical data managers on the regulatory and practical aspects of a clinical trial. To date, clinical data managers for most pharmaceutical and other bioscience companies must rely on “on the job” training to achieve the requisite skill set. In view of the above-described high stakes that are inevitably involved in a clinical trial, and the pressure on a drug company to successfully obtain authorization to market a new drug, there is little room for error or inefficiencies. Furthermore, once the risk to human safety is factored in during all phases of a clinical trial, the importance of skilled clinical data managers cannot be overlooked.

Thus, a need exists for a computer-based system for training and educating clinical data managers that perform various data related functions during clinical trials for pharmaceutical and other bioscience companies. A further need exists for a computer-based system for training and educating clinical data managers that allows such clinical data managers to practice their skills in a simulated laboratory environment, before life threatening human interaction is permitted.

### SUMMARY OF THE INVENTION

Generally, a method and apparatus are provided for training and educating clinical data managers that perform various data related functions during clinical trials for pharmaceutical and other bioscience companies. The present invention provides a clinical trial simulator using a combination of a simulated work environment, interactive multimedia, cohort teams, and specific clinical areas.

In one exemplary implementation of the invention, a modular training process is employed that is comprised of a number of exemplary modules that may generally be accessed in any order, unless a subsequent module receives the output of an earlier module as an input, as discussed further below. The exemplary modular training process consists of 12 illustrative modules, each covering a unique aspect of the drug development process. The simulated drug development process is tracked through the following 12 modules: an overview/compound selection process, a clinical trial design process, a data collection instrument design process, a database design process, a data acquisition process, a data quality process, a clinical lab data process, a dictionary coding process, a serious adverse events process, a study closeout activities process, a data analysis and reporting process, and an emerging issues process.

The modular approach of the present invention allows the modular training process to progressively expose clinical data managers to various issues (through a simulated environment) that are encountered in a real clinical data environment. Furthermore, the skills and deliverables associated with each module can be assessed and corrected, if necessary, before proceeding to a subsequent module. In this manner, a defect introduced by a user in an earlier module will not prevent the successful completion of a subsequent module.

The overview/compound selection process provides background knowledge of the evolution, development and current status of regulations within the pharmaceutical industry and an understanding of the process a new drug follows from discovery to marketing and the role of clinical trials in the drug development process. The clinical design process provides a detailed understanding of issues concerning the planning of a clinical study and the requirements of the Data Management Plan for a clinical study. The data collection instrument design process illustrates the efficient methods of collecting data from a clinical trial and methods of devising Data Collection Instruments (DCIs). The database design process illustrates the different types of databases and Clinical Trials Information Systems (CTIS) currently used for managing clinical trials data and the procedures of designing a clinical trial database. The data acquisition process illustrates how data is obtained from the clinical trial site in an efficient and timely fashion and the steps through which the raw data obtained from the site is converted into an electronic format.

The data quality process illustrates the significance of validating the acquired data, the types of data errors and the methods employed to identify and correct the invalid data and the process of clarifying data discrepancies. The clinical lab data process illustrates the importance of laboratory data in clinical trials and the management of clinical laboratory data. The dictionary coding process illustrates the importance of coding dictionaries as a consistent and ordered approach in data storage and retrieval as well as the types of coding, the dictionary architecture and their maintenance. The serious adverse events process illustrates serious events, the regulatory reporting requirement concerning serious events, and explains the existence of separate SAE and study databases, and the process of reconciling them. The study closeout activities process illustrates the database closure activities and their significance, as well as the procedures undertaken to assess the validity and reliability of the data, and to prepare the data for tabulation and reporting. The data analysis and reporting process illustrates the process of converting cleaned database into presentable table, graphs and listings and the presentation of a clinical trial report to the regulatory agencies. The emerging issues process makes participants aware of the regulatory environment, the audits and inspections, including new developments and future trends in the field of clinical data management.

A more complete understanding of the present invention, as well as further features and advantages of the present invention, will be obtained by reference to the following detailed description and drawings.

### BRIEF DESCRIPTION OF THE DRAWINGS

FIG. 1 illustrates the network environment in which the present invention can operate;

FIG. 2 is a schematic block diagram of an exemplary clinical trial simulator of FIG. 1;

FIG. 3 illustrates the modular training process of FIG. 2;

FIG. 4 is a flow chart describing an exemplary implementation of an overview/compound selection process of FIG. 3;

FIG. 5 is a flow chart describing an exemplary implementation of a clinical design process of FIG. 3;

FIG. 6 is a flow chart describing an exemplary implementation of a data collection instrument design process of FIG. 3;

FIG. 7A is a flow chart describing an exemplary implementation of a database design process of FIG. 3;

FIG. 7B is a sample header table that records the header information associated with an exemplary CRF section for rheumatoid arthritis;

FIG. 7C is a sample joint evaluation (jnteval) table that records the joint evaluation information (physician's assessment and characterization of the pain/tenderness and swelling of various indicated joints);

FIG. 7D is a sample self assessment (selfass) table that records the self assessment information (patient's assessment of overall arthritis pain and overall disease activity);

FIG. 8 is a flow chart describing an exemplary implementation of a data acquisition process of FIG. 3;

FIG. 9 is a flow chart describing an exemplary implementation of a data quality process of FIG. 3;

FIG. 9B is an exemplary graphical user interface that may be employed by a user in conjunction with the data quality process of FIG. 9A to generate and enter a query to identify a data discrepancy;

FIG. 10 is a flow chart describing an exemplary implementation of a clinical lab data process of FIG. 3;

FIG. 11A is a flow chart describing an exemplary implementation of a dictionary coding process of FIG. 3;

FIG. 11B is an exemplary user interface that may be employed by the dictionary coding process of FIG. 11A to present users with a list of various body systems, and request the selection of the body system corresponding to the adverse event;

FIG. 12A is a flow chart describing an exemplary implementation of a serious adverse events process of FIG. 3;

FIG. 12B illustrates the overlap between the general, project specific data and the serious adverse effect specific data of a clinical trial;

FIG. 13 is a flow chart describing an exemplary implementation of a study closeout activities process of FIG. 3;

FIG. 14 is a flow chart describing an exemplary implementation of a data analysis and reporting process of FIG. 3; and

FIG. 15 is a flow chart describing an exemplary implementation of an emerging issues process of FIG. 3.

### DETAILED DESCRIPTION

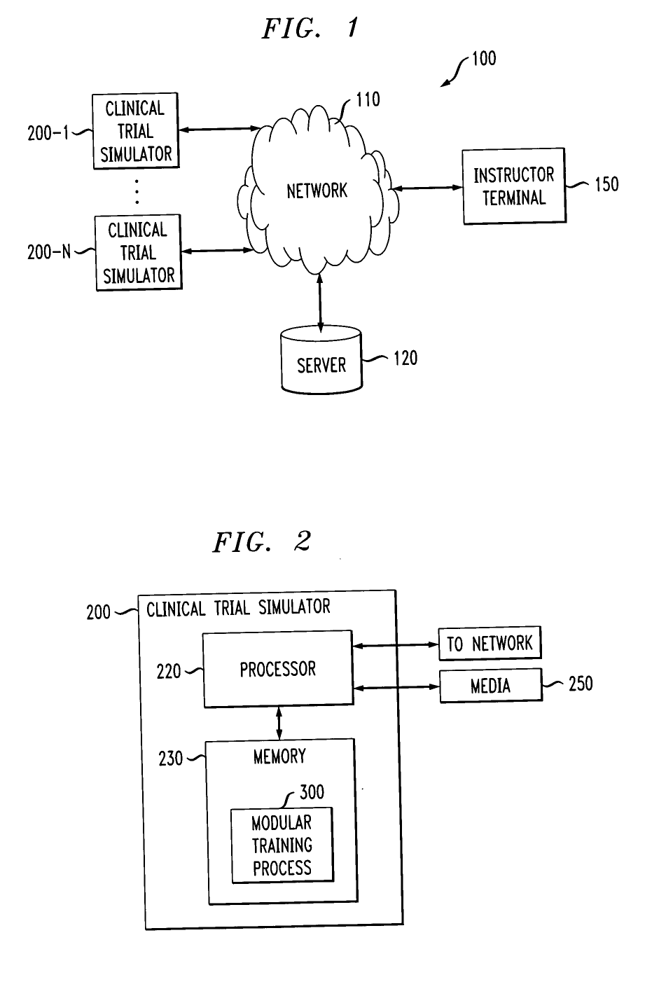

FIG. 1 illustrates the network environment 100 in which the present invention can operate. As shown in FIG. 1, one or more clinical trial simulators 200-1 through 200-N, hereinafter, collectively, referred to as clinical trial simulators 200 and discussed further below in conjunction with FIG. 2, are connected to a network 110, such as the Public Switched Telephone Network (PSTN) or the Internet. An instructor employing a terminal 150 can optionally participate to supervise and instruct the activities of the clinical trial simulators 200. In addition, a server 120 may optionally be employed to record methods and/or data employed by the clinical trial simulators 200 or instructor terminal 150. The present invention provides a clinical trial simulator using a combination of a simulated work environment, interactive multimedia, cohort teams, and specific clinical areas.

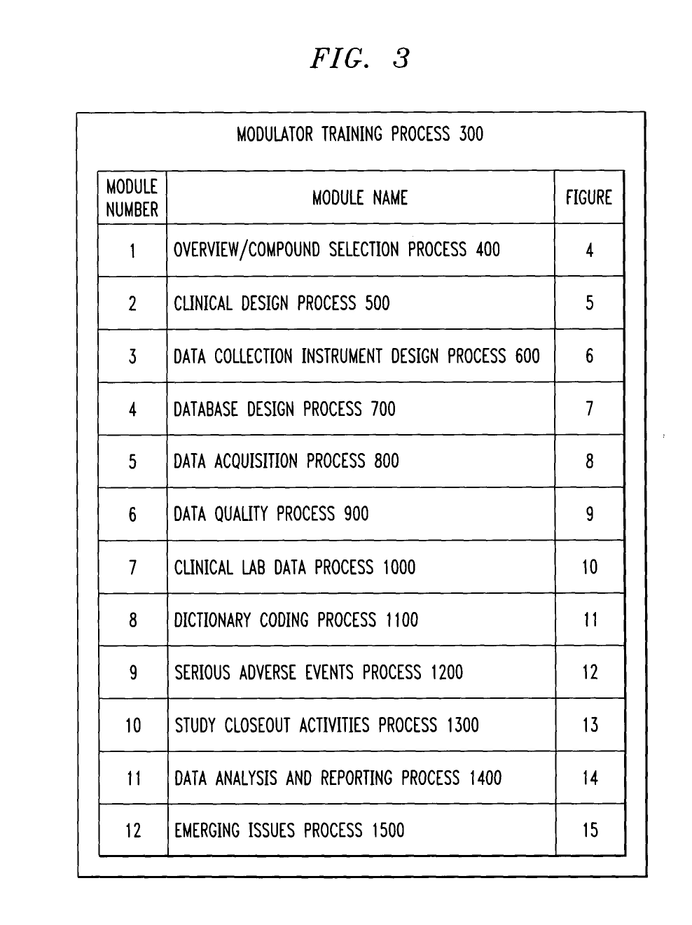

FIG. 2 is a schematic block diagram of an exemplary clinical trial simulator 200. As shown in FIG. 2, a clinical trial simulator 200 comprises a processor 220 and a memory 230, which itself comprises a modular training process 300, discussed below in conjunction with FIG. 3. The clinical trial simulator 200 may be embodied as any computing device, such as a personal computer or workstation, containing a processor 220, such as a central processing unit (CPU), and memory 230, such as Random Access Memory (RAM) and Read-Only Memory (ROM). In an alternate embodiment, the clinical trial simulator 200 disclosed herein can be implemented as an application specific integrated circuit (ASIC).

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium 250 (e.g., floppy disks, hard drives, compact disks, DVD, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer readable code means is any mechanism for allowing a computer to read instructions and data, such as magnetic variations on a magnetic media or height variations on the surface of a compact disk, such as DVD.

Memory 230 will configure the processor 220 to implement the methods, steps, and functions disclosed herein. The memory 230 could be distributed or local and the processor 220 could be distributed or singular. The memory 230 could be implemented as an electrical, magnetic or optical memory, or any combination of these or other types of storage devices. The term “memory ” should be construed broadly enough to encompass any information able to be read from or written to an address in the addressable space accessed by processor 220. With this definition, information on a network is still within memory 230 of the clinical trial simulator 200 because the processor 220 can retrieve the information from the network.

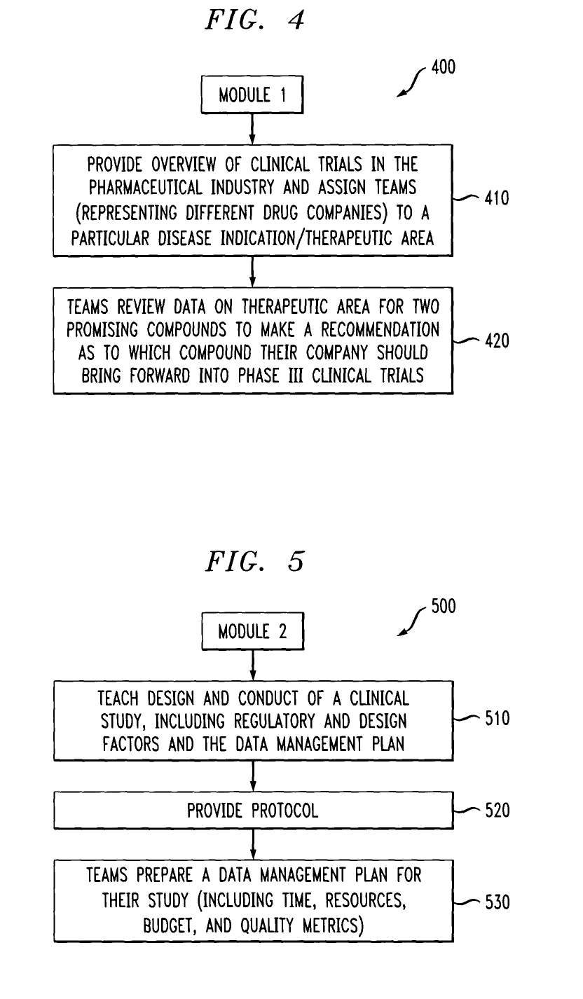

FIG. 3 illustrates the modular training process 300. As shown in FIG. 3, the modular training process 300 is comprised of a number of exemplary modules that may generally be accessed in any order, unless a subsequent module receives the output of an earlier module as an input, as discussed further below. The exemplary modular training process 300 consists of 12 illustrative modules, each covering a unique aspect of the drug development process. As discussed further below in conjunction with FIGS. 4 through 15, respectively, the drug development process is tracked through the following 12 modules: an overview/compound selection process 400, a clinical trial design process 500, a data collection instrument design process 600, a database design process 700, a data acquisition process 800, a data quality process 900, a clinical lab data process 1000, a dictionary coding process 1100, a serious adverse events process 1200, a study closeout activities process 1300, a data analysis and reporting process 1400, and an emerging issues process 1500.

The modular approach of the present invention allows the modular training process 300 to progressively expose clinical data managers to various issues (through a simulated environment) that are encountered in a real clinical data environment. Furthermore, the skills and deliverables associated with each module can be assessed and corrected, if necessary, before proceeding to a subsequent module. In this manner, a defect introduced in an earlier module will not prevent the successful completion of a subsequent module.

### Overview/Compound Selection Process

FIG. 4 is a flow chart describing an exemplary implementation of an overview/compound selection process 400. Generally, the overview/compound selection process 400 provides background knowledge of the evolution, development and current status of regulations within the pharmaceutical industry and an understanding of the process a new drug follows from discovery to marketing and the role of clinical trials in the drug development process.

As shown in FIG. 4, the overview/compound selection process 400 initially provides an overview of clinical trials in the pharmaceutical industry during step 410 and assigns teams (representing different drug companies) to a particular disease indication/therapeutic area. The teams then review data on a therapeutic area for two promising compounds to make a recommendation as to which compound their company should bring forward into phase III clinical trials during step 420.

The goal of the overview/compound selection process 400 is to familiarize students with assigned therapeutic areas and to recommend a promising compound for Phase III clinical trials. The goals for any compound are: acquire FDA approval to market the drug, fulfill an unmet medical need, and to provide the maximum return on investment.

Thus, the overview/compound selection process 400 presents exemplary marketing, demographic and current treatment information regarding a particular therapeutic area, such as anti-inflammatory treatments. In addition, detailed information is presented on a number of potential compounds that could possibly be evaluated during a clinical trial.

Based on the presented information, a compound must be selected that offers the best possibility for drug development for the rest of the program. The overview/compound selection process 400 introduces students to many of the competing factors and organizational elements involved in the drug development process.

### Clinical Design Process

FIG. 5 is a flow chart describing an exemplary implementation of a clinical design process 500. Generally, the clinical design process 500 provides a detailed understanding of issues concerning the planning of a clinical study and the requirements of the Data Management Plan for a clinical study. As shown in FIG. 5, the clinical design process 500 initially teaches about the design and conduct of a clinical study, including regulatory and design factors and the data management plan during step 510. Thereafter, students are presented with a protocol during step 520. Finally, teams prepare a Data Management Plan for their study (including time, resources, budget, and quality metrics) during step 530.

The protocol provided during step 520 describes the objective(s), design, methodology, statistical considerations, and organization of a trial, in a known manner. In general, the protocol also gives the background and rationale for the trial. The protocol serves a variety of important purposes. For example, a study protocol provides the following

a planning document; by reading the protocol, management should be able to see how the study fits into the overall development plan for an investigational drug;

detailed instructions for the study team and other participants on what to do in conducting the study; clear and direct terms that provide concrete and unambiguous decision-making criteria;

a study agreement between the sponsor and the investigator by specifying what services are to be performed;

a standard for all study procedures so that the study can be replicated, if necessary;

documentation of the study design, objectives, conditions, and methodology for regulatory and ethical review purposes;

The protocol is the definitive document against which the trial will be conducted, audited, inspected, and the study report written. Every protocol must include information about the study's design, study treatments, and safety reporting. In particular, it must include a section on Adverse Events and Serious Adverse Events. A protocol is drafted by a team of medical and statistical experts. A typical protocol will include the following sections: background/rationale of study, objectives, design, efficacy and safety responses, statistical analyses, sample size & its rationale, patient selection criteria, safety issues, and regulatory issues.

The clinical design process 500 allows students to review a simulated, partial protocol and to identify problems. After reviewing the protocol, students are required to identify problem sections and validate the protocol content. Students are provided with feedback on how the identified problems.

Once a protocol is written, several other documents can then be created, including a Data Management Plan. A Data Management Plan, written at the start of a study, provides a focus for identifying the work to be performed, who will perform it, and what is to be produced as documentation. Most Data Management Plans are “living documents” that get updated throughout the study.

The Data Management Plan (DMP) should touch on all the elements of the data management process for the study in question. A typical DMP includes the following elements: study setup; tracking CRF data; entering data; managing lab data; identifying and managing discrepancies; collecting adverse event data; coding reported terms; creating reports and transferring data; and closing studies. There are several places throughout the clinical trial process where errors in the data can be introduced. To ensure that the errors associated with testing, collecting, analyzing and reporting data are minimized, biopharmaceutical firms establish Quality Assurance plans as part of their data management plans. In addition, firms rely on Standard Operating Procedures (SOPs) or other guidelines to help with containing errors. Data managers primarily have responsibility for ensuring data quality once it is received in-house (at the sponsor).

The clinical design process 500 includes a feature to depict where data is generated, handled and managed in the clinical trials process. The clinical design process 500 allows students to review the various data paths and identify where a data manager would have primary responsibility for error checking. The student must identify potential errors (if any) that should be monitored for quality by the data manager.

### Data Collection Instrument Design Process

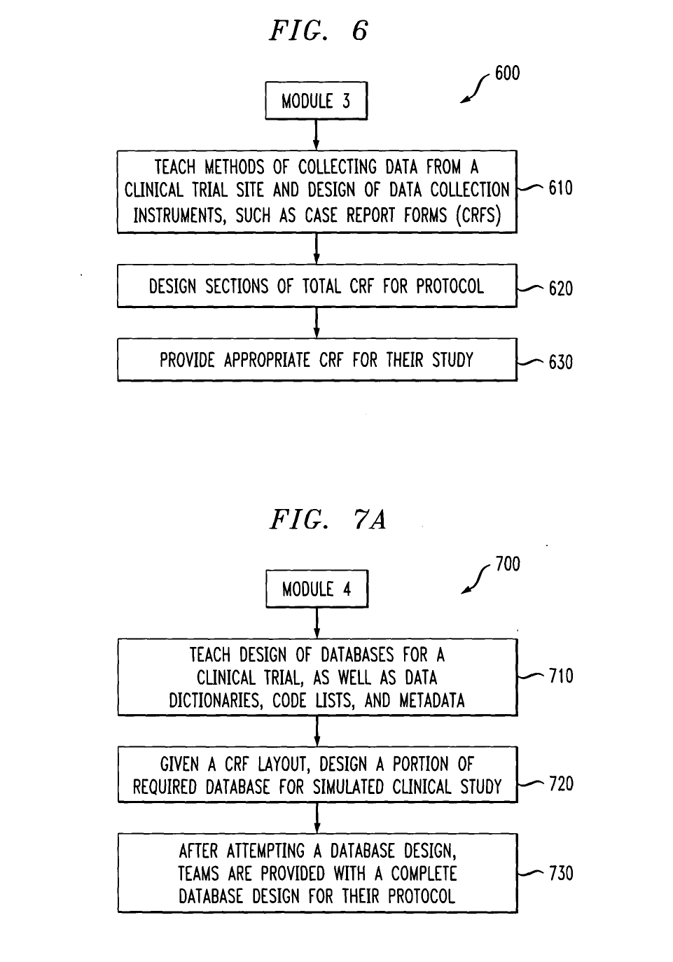

FIG. 6 is a flow chart describing an exemplary implementation of a data collection instrument design process 600. Generally, the data collection instrument design process 600 illustrates the efficient methods of collecting data from a clinical trial and methods of devising Data Collection Instruments (DCIs). As shown in FIG. 6, the data collection instrument design process 600 initially teaches methods of collecting data from a clinical trial site and the design of data collection instruments, such as Case Report Forms (CRFS) during step 610. Thereafter, the data collection instrument design process 600 illustrates how to design sections of a total CRF for a protocol during step 620. Finally, students are provided an appropriate CRF for their study during step 630.

The Case Report Form (CRF) is the main data collection instrument (DCI) used in the clinical trials process. The CRF is the official working document used by investigators for recording all trial-related data for each subject in a clinical study. The CRF is developed in conjunction with the protocol. This is typically a paper-based form designed to collect all data required by the study design as described in the protocol.

A CRF contains several data modules that provide for collecting data in a number of areas including demographic data, efficacy data, and safety data (including adverse events). Each data module should be designed to be easily filled in, foster consistency in data entry, and as concise as possible.

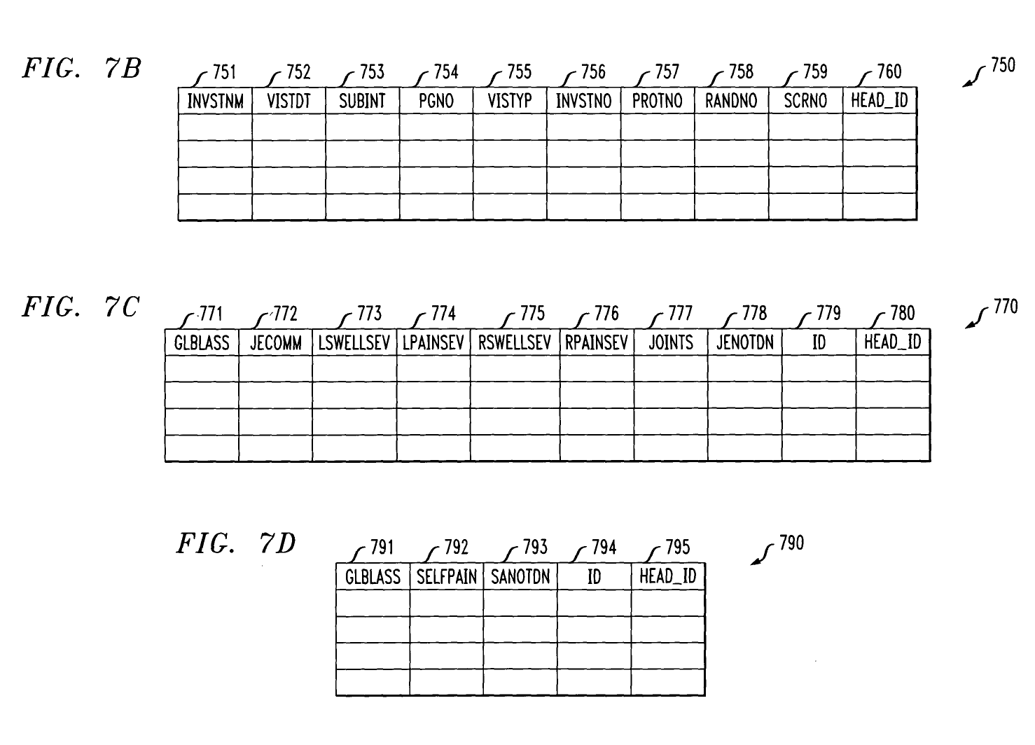

A CRF for an exemplary rheumatoid arthritis ailment, for example, would typically provide (i) a header section, (ii) a section for the physician to assess and characterize the pain/tenderness and swelling of various indicated joints of the patient on the left and right side of the body; and (iii) section for the patient to provide a self assessment of overall arthritis pain and overall disease activity. Exemplary data for a CRF for an exemplary rheumatoid arthritis ailment is discussed further below in conjunction with FIGS. 7B through 7D.

The data collection instrument design process 600 allows a student to review particular sections of a CRF along with its protocol. The data collection instrument design process 600 presents a list of variables, and students must identify which variables should generally be required in a demographic module in a Case Report Form (collecting only the data required by the protocol, while being clear and concise and avoiding data redundancies). A further feature of the data collection instrument design process 600 can present alternate designs to organize demographic variables on a CRF and students can select which design would record demographic data most efficiently and accurately.

### Database Design Process

FIG. 7A is a flow chart describing an exemplary implementation of a database design process 700. Generally, the database design process 700 illustrates the different types of databases and Clinical Trials Information Systems (CTIS) currently used for managing clinical trials data and the procedures of designing a clinical trial database. As shown in FIG. 7A, the database design process 700 initially teaches about the design of databases for a clinical trial, as well as data dictionaries, code lists, and metadata during step 710. Thereafter, given a CRF layout, a student must design a portion of one or more required database(s) for the simulated clinical study during step 720. Finally, after attempting a database design, teams are provided with a complete database design for their protocol during step 730.

Database designing involves determining how items will be organized into tables, and choosing the appropriate data type and size for each field. It is also important to ensure “referential integrity,” such that important relationships among fields residing in different tables are accurately represented and that data that has been duplicated in multiple tables are consistent (as well as accurate). Most database systems, such as Microsoft Access™, allows the designer to control the following table properties in conjunction with database definition:

Require information to be provided for a field

Define the acceptable format for supplying information for a field

Prohibit duplicate entries for a field

Provide a “validation rule” for a field (data entry checks)

Define a “validation rule” for a record (data entry checks)

Each drug study generates massive amounts of data. The study sponsor is responsible for all of this data, and must prove to the FDA that the data was collected, managed, and reported in accordance with the reviewed protocol. Trials data is typically stored in relational database systems such as Oracle™. Every parameter required to be collected by the protocol must be included in the database. Every data item in the study database must also be reported to the FDA.

In a clinical trial database, related parameters are grouped into one data-table. For example, a demographic data table may contain the parameters of date of birth, height and weight. In addition, each table should also contain variables which help in uniquely identifying each record. The database design process 700 can require students to associate parameters with tables.

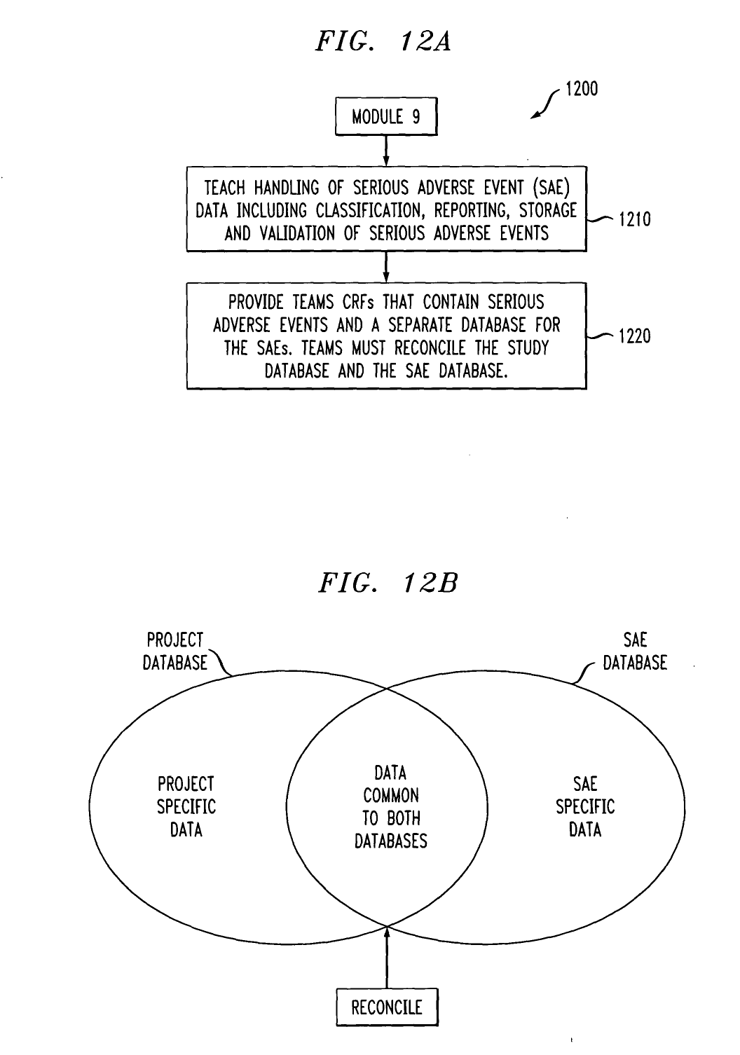

An important aspect of data management in the clinical trials process is the management of Serious Adverse Events (SAEs) data, as discussed further below in conjunction with FIG. 12. A sponsor is under legal obligation to report occurrences of SAEs on a regular and expedited base to the regulatory authorities. Thus, in terms of database design and development, the database design process 700 illustrates how SAE data is best handled. The database design process 700 interacts with a user to create a new database just for SAEs.

In addition, all data management plans must deal with how to handle normal ranges as specified by laboratories. The database design process 700 interacts with users to account for ambiguities and miscoding in the specified ranges. For example, normal ranges for a given parameter can be specified as follows:

| Age | Normal Range |
|---|---|
| 10-20 | 80-90 |
| 20-60 | 100-102 |

Thus, it is unclear what the correct range should be for a person that is 20 years old. Thus, to satisfy the requirements of an exemplary implementation of the database design process 700, the user must query the laboratory to clarify the normal range for a 20 year old.

As previously indicated, a CRF for an exemplary rheumatoid arthritis ailment may provide (i) a header section, (ii) a section for the physician to assess and characterize the pain/tenderness and swelling of various indicated joints of the patient on the left and right side of the body; and (iii) a section for the patient to provide a self assessment of overall arthritis pain and overall disease activity. Using the database design process 700, a student may design the databases shown in FIGS. 7B through 7D to record such data.

FIG. 7B is a sample header table 750 that records the header information associated with an exemplary CRF section for rheumatoid arthritis. As shown in FIG. 7B, the header table 750 includes an INVSTNM field 751 indicating the investigator's name; a VISTDT field 752 indicating the visit date; a SUBINT field 753 indicating the subject's initials; a PGNO field 754 indicating the CRF page number; a VISTYP field 755 indicating the visit type; an INVSTNO field 756 indicating the investigator's number; a PROTNO field 757 indicating the protocol number that may be used, e.g., to combine all of the studies for one drug into integrated summaries; a RANDNO field 758 indicating a randomization number that must be unique and keeps the study blinded; a SCRNO field 759 indicates the screening number and must be unique and is also important for blinding and identification purposes; and a HEAD_ID field 760 that is the Primary Key field for the header table 750. The HEAD_ID field 760 holds the data that uniquely identifies each record in this table 750.

FIG. 7C is a sample joint evaluation (jnteval) table 770 that records the joint evaluation information (physician's assessment and characterization of the pain/tenderness and swelling of various indicated joints). As shown in FIG. 7C, the joint evaluation table 770 includes a GLBLASS field 771 that indicates the physician's global assessment of the disease activity (global in the sense that it's not local to shoulders, elbows, etc.); a JECOMM field 772 indicating comments (optional) for this page in the CRF book; a LSWELLSEV field 773 indicating the swelling severity (e.g., 0=none, 1=mild) for a particular joint on the left side; a LPAINSEV field 774 indicating the pain severity for a particular joint on the left side; a RSWELLSEV field 775 indicating the swelling severity for a particular joint on the right side; a RPAINSEV field 776 indicating the pain severity for a particular joint on the right side; a JOINTS field 777 indicating the joint number (e.g., 1=shoulder, 2=elbow); a JENOTDN field 778 indicating whether or not the assessment was done (a “1” indicates it was not done and all swellsev and painsev fields should be blank); an ID field 779 providing the primary key for this table (an autonumber starting at 1 and incremented automatically); and a HEAD_ID field 780, a key field that provides relationship information for all of this data (relating the data to a particular patient).

FIG. 7D is a sample self assessment (selfass) table 790 that records the self assessment information (patient's assessment of overall arthritis pain and overall disease activity). As shown in FIG. 7D, the self assessment table 790 includes a GLBLASS field 791 indicating the patient self-assessment of overall disease activity; a SELFPAIN field 792 indicating the patient's self assessment of arthritis pain; a SANOTDN field 793 indicating the parameter that indicates whether or not the patient self-assessment was even done (1=not done, blank means it was done and there will be data for pain, etc.); an ID field 794 is the primary key variable for this table; a HEAD_ID field 795 is a key variable signifying a relationship exists within the database (equating particular patient self-assessment to a particular patient and a particular visit).

### Data Acquisition Process

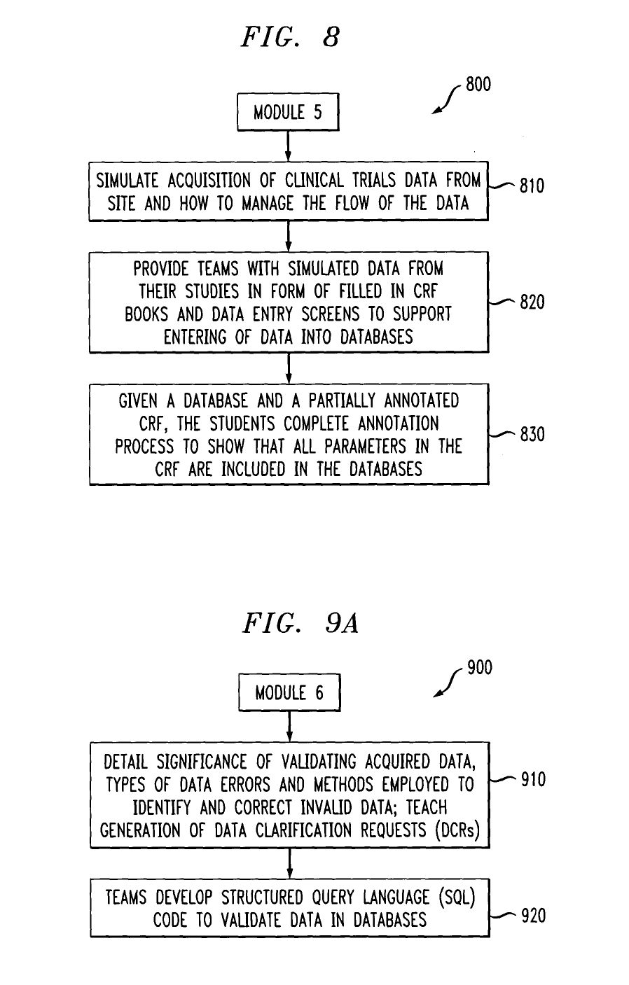

FIG. 8 is a flow chart describing an exemplary implementation of a data acquisition process 800. Generally, the data acquisition process 800 illustrates how data is obtained from the clinical trial site in an efficient and timely fashion and the steps through which the raw data obtained from the site is converted into an electronic format. As shown in FIG. 8, the data acquisition process 800 initially simulates the acquisition of clinical trial data from a site and the management of the flow of the data during step 810. The data acquisition process 800 then provides teams with simulated data from their studies in the form of one or more filled in CRF books and data entry screens to support the entering of data into the appropriate databases during step 820. Finally, given a database and a partially annotated CRF, the students complete the annotation process to show that all parameters in the CRF are included in the databases during step 830. In other words, the data acquisition process 800 ensures that all data obtained during the clinical trial and recorded in a CRF is being properly recorded in electronic form in an appropriate database. For example, the data acquisition process 800 can ensure that each parameter recorded in a field of the CRF is properly mapped to a database, and that the code list, representing possible entries for each parameter, are accurate.

### Data Quality Process: DCRs and SQL Queries

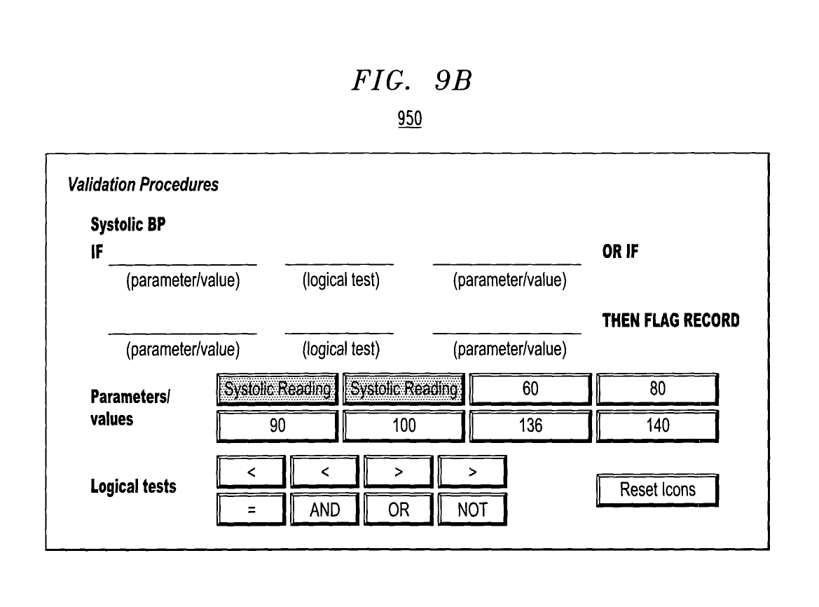

FIG. 9A is a flow chart describing an exemplary implementation of a data quality process 900. Generally, the data quality process 900 illustrates the significance of validating the acquired data, the types of data errors and the methods employed to identify and correct the invalid data and the process of clarifying data discrepancies. As shown in FIG. 9A, the data quality process 900 initially details the significance of validating acquired data, the types of data errors and the methods employed to identify and correct invalid data during step 910. In addition, the students must also generate data clarification requests (DCRs) during step 910. Thereafter, the teams develop code, such as Structured Query Language (SQL) code, to validate the data in the databases during step 920. SQL statements may be used to check data items within and across tables.

Discrepancies are any inconsistencies in the clinical data that require research. Discrepancies may be identified manually anytime during processing when someone reviews either the CRF or the data. Discrepancies may be identified by the data management system automatically at entry or after entry. Alternatively, discrepancies may be identified through reporting or analysis in systems external to the data management application. Most of the discrepancies that are identified by the data manager are dependent on input from the investigational site to be resolved. These discrepancies are sent to the site as queries on special forms called Data Clarification Requests (DCR) (these forms are also referred to as data corrections forms, discrepancy forms, and query forms). Data Clarification Requests identify the data discrepancy in a way that is understandable to the site. The discrepancies may be entered onto the form by hand, based on reports from the discrepancy management system, or the system may create them automatically. The DCR is then delivered to the site.

The site researches the discrepancies and provides resolutions using a company specified method. For paper-based processes, the site may indicate the resolution on the DCR form itself, or the site may correct and re-send the CRF. For remote data entry systems, the DCRs are really query reports, which tell the site about problems to investigate. The site then makes the corrections directly to the data themselves. Data management receives the DCRs or corrected CRFs or corrected data and updates the discrepancy information appropriately. For paper-based processes, they will also update the data as needed.

Prior to commencing the study, the data management team must have data validation procedures in place to ensure data accuracy and integrity. Data validation includes checking data ranges, looking for inconsistencies and flagging abnormal results.

FIG. 9B is an exemplary graphical user interface 950 that may be employed by a user in conjunction with the data quality process 900 to generate and enter a query to identify a data discrepancy. Generally, the graphical user interface 950 allows a user to employ a drag and drop approach, to complete an IF-THEN statement for each data item to be evaluated. The user must drag the appropriate parameter, value and logical test operator, into the appropriate spaces to develop a procedure that automatically identifies instances where a parameter is outside a normal range. In one preferred embodiment of the invention, the data quality process 900 allows a user to develop data validation procedures for a number of different parameters using natural language constructs in order to identify errors that have been intentionally included in the data.

The data quality process 900 can provide the user with a graphical user interface to write a SQL statement to verify, for example, that the subject's initials were provided, as follows:

SELECT * FROM DEMOG WHERE SubInitials IS NULL OR SubInitials=“ where the asterisk (*) indicates a particular table.

Similarly, the data quality process 900 can provide the user with a graphical user interface to write a SQL statement to verify, for example, that the subject's race was provided, as follows:

SELECT * FROM DEMOG WHERE Race=4 AND (RaceOther IS NULL OR RaceOther=“).

The data quality process 900 can provide the user with a graphical user interface to write a SQL statement to discover, for example, whether any visit dates are later than the current calendar date:

SELECT * FROM VISIT WHERE VisitDate>Now( )

The data quality process 900 can provide the user with a graphical user interface to write a SQL statement to check that information in related fields within the same table is reasonable. For example, a user can write a SQL statement to discover any subjects whose height does not appear to be consistent with the units specified, given that subjects should be at least 5 feet tall, as follows:

SELECT * FROM DEMOG WHERE ((Height<(60*2.54)) AND (HeightType=2)) OR ((Height<60) AND (HeightType=1))

### Clinical Lab Data Process

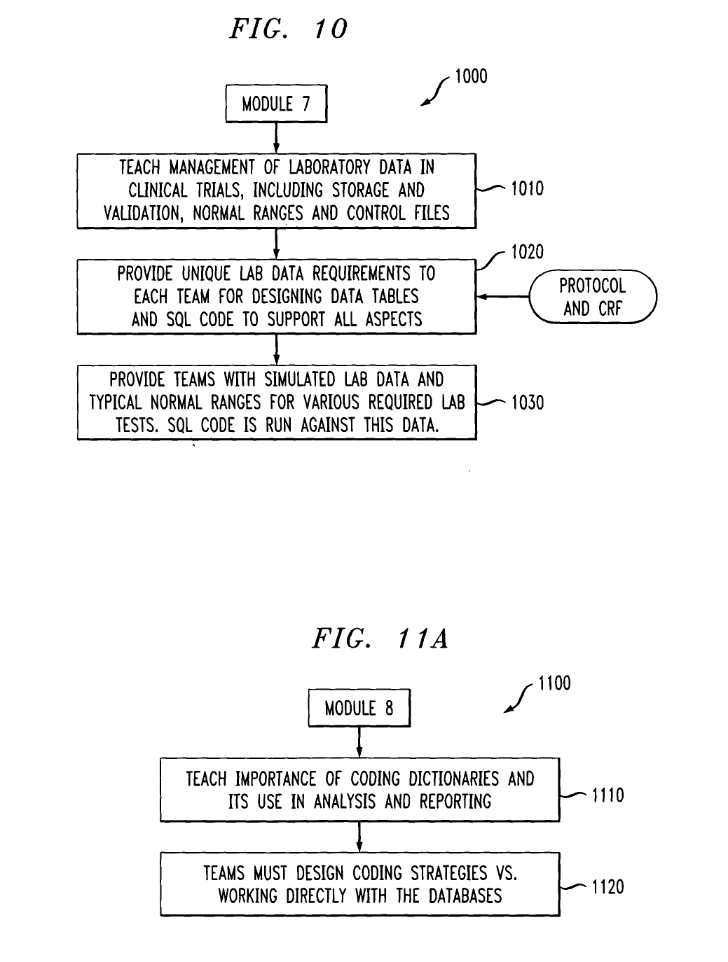

FIG. 10 is a flow chart describing an exemplary implementation of a clinical lab data process 1000. Generally, the clinical lab data process 1000 illustrates the importance of laboratory data in clinical trials and the management of clinical laboratory data. As shown in FIG. 10, the clinical lab data process 1000 initially teaches the management of laboratory data in clinical trials, including storage and validation, normal ranges and control files during step 1010. Thereafter, the clinical lab data process 1000 provides unique lab data requirements to each team for designing data tables and SQL code to support all aspects during step 1020. Finally, teams are provided with simulated lab data and typical normal ranges for various required lab tests during step 1030 and the SQL code is run against this data. For example, normal range information can be presented in the form of a table identifying a particular test, indicating the units in which the test results are normally expressed, and indicating the normal range separately for males and females.

Once pre-study planning is complete, the trial can begin. Most trial data comes in the form of the Case Report Forms. Some study data also comes in an electronic format. Non-CRF data can include laboratory results, such as ECG tests or diagnostic imaging data. CRFs are used to collect all parameters that are specified by the study's protocol and are required by the FDA. The clinical lab data process 1000 enables students to access a CRF and other data sources and instructs the students to review the various data sources including CRFs and lab reports. The clinical lab data process 1000 interacts with students to review the attached CRF and identify any items that require action. In one exemplary embodiment, students receive a CRF with known mistakes, problems or issues. Students must flag the errors or problems in the CRF (CRF may contain, for example, lab data and a serious adverse event).

### Dictionary Coding Process

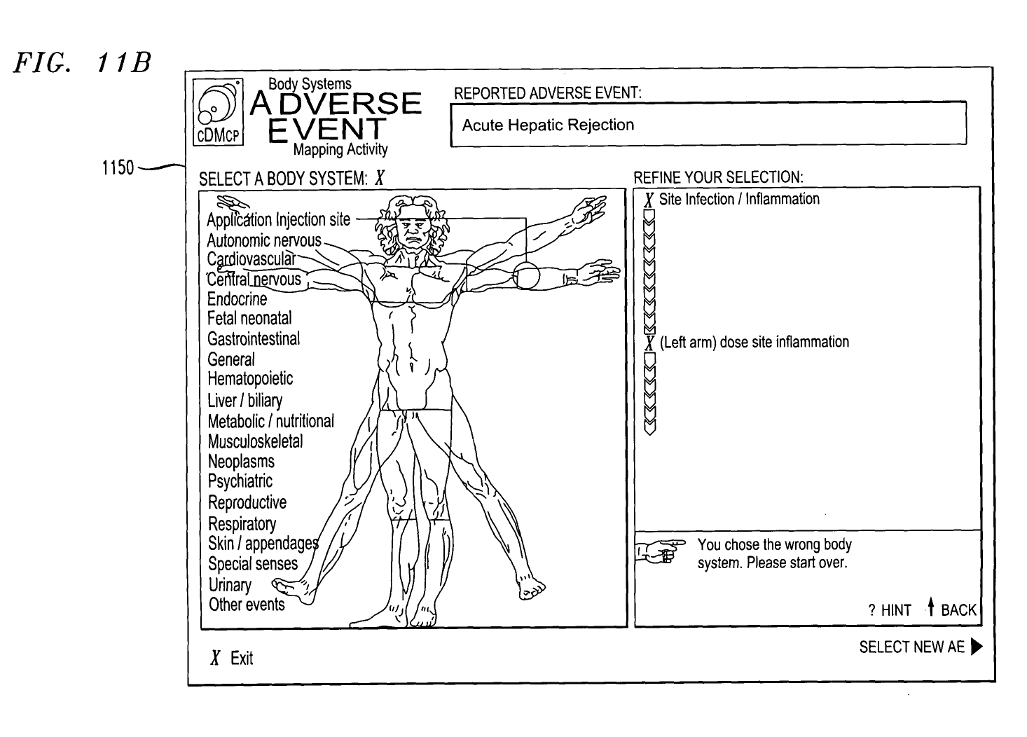

FIG. 11A is a flow chart describing an exemplary implementation of a dictionary coding process 1100. Generally, the dictionary coding process 1100 illustrates the importance of coding dictionaries as a consistent and ordered approach in data storage and retrieval as well as the types of coding, the dictionary architecture and their maintenance. As shown in FIG. 11A, the dictionary coding process 1100 initially teaches the importance of coding dictionaries and its use in analysis and reporting during step 1110. Thereafter, teams must design coding strategies (vs. working directly with the databases) during step 1120.

It is almost impossible to do an automated statistical analysis of text data. If textual or free text data are collected and reported, they are usually coded before they can be aggregated and used in summary analyses. “Coding” simply means assigning numbers to various predetermined text options. For example, for the sex variable in a database, a value of “1” can indicate a “Male” and a value of “2” can indicate a “Female.” Similarly, answers to some other questions might be coded as a value of “1” can indicate a “YES” answer and a value of “2” can indicate a “NO” answer. As numbers are easier to analyze using software, coding is very important.

This simple arrangement of codes and their decodes is called a codelist. Not all data can be coded in this simple manner. For certain parameters, such as adverse events, medications and diseases, more complex coding is required where there exists a hierarchical structure. Such complex coding is done by “coding dictionaries.” Medical history, adverse events, procedures and medications are usually coded with standard dictionaries. The coding process consists of matching text collected on the CRF to terms in a standard dictionary. There are often items that cannot be matched or coded without clarification from the site.

The dictionary coding process 1100 can assist the user with mapping adverse events to dictionary codes. The dictionary coding process 1100 interacts with users to initially identify an adverse event, as it shows up on a CRF, that must be coded. The dictionary coding process 1100 can present the users with a list of various body systems, such as autonomic nervous, cardiovascular and central and peripheral nervous systems, and request the selection of the body system corresponding to the adverse event, for example, using the user interface 1150 shown in FIG. 11B.

Each of the systems shown in FIG. 11B corresponds to a “hot spot” on the body graphic (male or female). Clicking on the hot spot (head/brain area for central/periph. nervous system, the heart for cardiovascular, the lungs for respiratory, etc.) will cause the dictionary coding process 1100 to present another graphic image that allows for further choices down that specific node.

Thus, if a user selects the cardiovascular system by clicking on the text or corresponding picture of the heart in the body, the user is presented with a new menu/image map. For instance, the second level of choice after picking cardiovascular is: cardiovascular general, heart rate/rhythm, myo-, endo-, pericardial and valve, and vascular (extracardiac). If the user selects vascular (extracardiac), the dictionary coding process 1100 presents another image/graphic where the user chooses a particular organ or function (e.g., vision). After this level, the dictionary coding process 1100 then presents a screen that has a list of possible adverse events, where they either match the one on the CRF or the user must try again. If the adverse event is not in the list, then the user knows that he or she did not map the event correctly. At this point, users can “back up” some number of levels in the branching.

After some number of unsuccessful attempts to map the event to the specific code, the dictionary coding process 1100 can optionally offer the user a clue/hint, indicating where their first incorrect choice was. This way they will at least know how far back to go to try again. For example, if the user got the body system correct (e.g., cardiovascular), but then picked “Heart rate/rhythm” instead of “vascular,” the dictionary coding process 1100 could send them back to that decision point, rather than sending them all the way back to the body system choice (which they correctly made).

When the user has correctly mapped the adverse event, the dictionary coding process 1100 can pop open an additional window that shows the data dictionary path (text, codes, diagram-style). The user then is given another adverse event term as found on the CRF and the activity starts over.

For example, if an investigator writes “above orbites headache” in the Adverse Events section of the CRF, the student must map that adverse event to the appropriate code in the Adverse Events Dictionary. This example maps as follows:

First level—Central and Peripheral nervous system

Second level—Headache

Third level—above orbites headache (World Health Organization) (WHO) code is R337-192927)

Similarly, if an investigator writes “bleeding of ocular fundus” in the CRF, the student must map that adverse event to the appropriate code in the Adverse Events Dictionary. This example maps as follows:

First level—Cardiovascular

Second level—Vascular (extra cardiac)

Third level—vision

Fourth level—ocular hemorrhage

Maps to “Bleeding of ocular fundus” (WHO code R12858-100579)

### Serious Adverse Events Process

FIG. 12A is a flow chart describing an exemplary implementation of a serious adverse events process 1200. Generally, the serious adverse events process 1200 illustrates serious events, the regulatory reporting requirement concerning serious events, and explains the existence of separate SAE and study databases, and the process of reconciling them. As shown in FIG. 12A, the serious adverse events process 1200 initially teaches the handling of serious adverse event (SAE) data including classification, reporting, storage and validation of serious adverse events during step 1210. Thereafter, the serious adverse events process 1200 provides teams with one or more CRFs that contain serious adverse events and a separate database for the SAEs during step 1220. The teams must then reconcile the study database and the SAE database.

The FDA defines a Serious Adverse Event (SAE) as any untoward medical occurrence that results in death, is life-threatening, requires or prolongs hospitalization, causes persistent or significant disability/incapacity, results in congenital anomalies/birth defects, or in the opinion of the investigators represents other significant hazards or potentially serious harm to research subjects or others. A serious adverse event is considered unexpected if it is not described in the Package Insert or in the Investigator's Brochure (for FDA investigational agents), in the protocol, or in the informed consent document.

During a drug trial, serious adverse events are recorded both in the adverse events section of the CRF as well as on a separate, more detailed, Serious Adverse Event form. FIG. 12B illustrates the overlap between the general, project specific data and the SAE specific data. As shown in FIG. 12B, the overlapping data that is common to both databases must be reconciled. The SAE form contains additional information that usually comes from multiple sources to support Good Clinical Practices. All SAE information is usually stored in a database separate from the study database.

The serious adverse events process 1200 interacts with the users to review the provided SAE and CRF data and identify those fields and/or data items that are common to both databases, and therefore need to be reconciled.

### Study Closeout Activities Process

FIG. 13 is a flow chart describing an exemplary implementation of a study closeout activities process 1300. Generally, the study closeout activities process 1300 illustrates the database closure activities and their significance, as well as the procedures undertaken to assess the validity and reliability of the data, and to prepare the data for tabulation and reporting. As shown in FIG. 13, the study closeout activities process 1300 initially teaches the closing of a database and the preparation of a database for table generation and reporting, emphasizing database audits and the performance of an unblinding of a database during step 1310. Thereafter, the study closeout activities process 1300 interacts with users to perform an audit in accordance with the quality plan in the DMP during step 1320, given a set of paper CRFs and populated databases. Finally, given unblinding data in a spreadsheet, the users perform an unblinding during step 1330.

Generally, a given clinical trial for a compound also includes one or more control compounds, such as a placebo, to evaluate the relative effectiveness of the compound being studied. During the clinical trial, the particular compound being administered to each patient is kept confidential or “masked.” Such blinding techniques increase the objectivity of the person(s) observing experimental outcomes, decreases bias and is particularly important in trials that require self-reporting or self-assessments. In a “single blind” scenario, the patient is unaware of which treatment is being received while the investigator has this information. In a “double blind” scenario, neither the patient nor the investigator is aware of which treatment the patient is receiving.

During the clinical trial, patients are assigned to a treatment arm through a technique called randomization. The randomization data is maintained in a separate, well guarded database. Thus, once the clinical trial is complete, unblinding is required prior to reporting, in order to present results in association with treatment groups.

The unblinding process typically has two tables (apart from the dosing record table), indicating the treatment group and the randomization mapping. These tables contain information per protocol on the treatment groups. For example, a treatment group A may be given Drug X, 100 mg. Capsule while treatment group B is given a placebo capsule. The mapping table contains the mapping of treatment groups to randomization numbers and may be unpopulated during the conduct of the trial. Unblinding is achieved by pulling information from the separate randomization database into this table.

The study closeout activities process 1300 allows students to perform an unblinding for the project database. Students are provided an “Unblinding Data” spreadsheet and must verify whether the unblinding occurred properly

### Data Analysis And Reporting Process

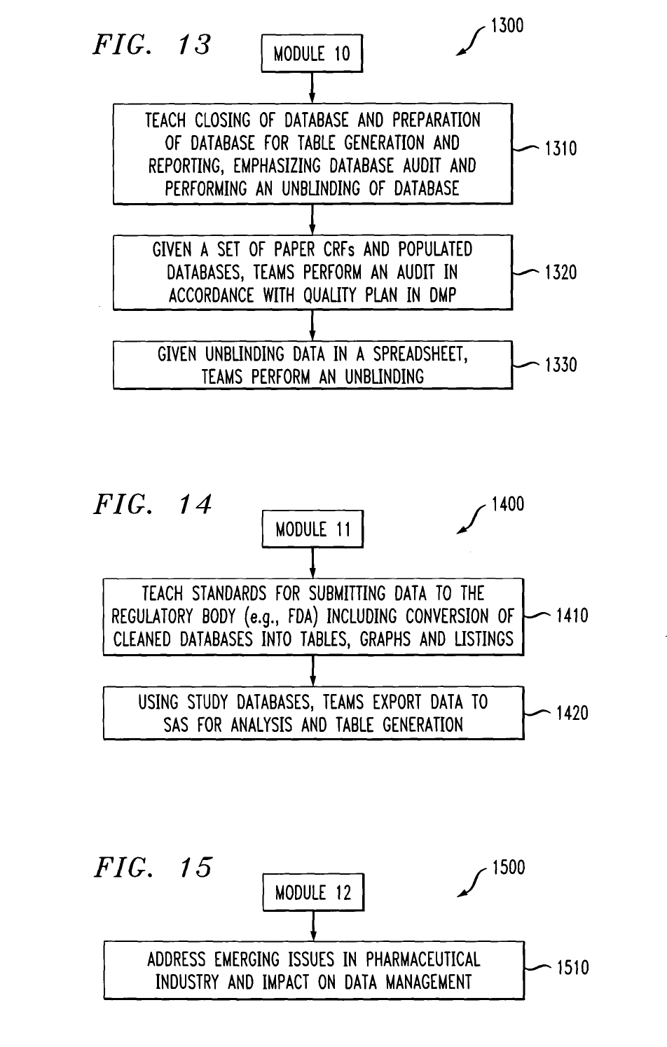

FIG. 14 is a flow chart describing an exemplary implementation of a data analysis and reporting process 1400. Generally, the data analysis and reporting process 1400 illustrates the process of converting cleaned database into presentable table, graphs and listings and the presentation of a clinical trial report to the regulatory agencies. As shown in FIG. 14, the data analysis and reporting process 1400 initially teaches standards for submitting data to the regulatory body (e.g., FDA) including the conversion of cleaned databases into tables, graphs and listings during step 1410. Thereafter, using study databases, teams export the data to a software program, such as Statistical Analysis System (SAS), for analysis and table generation during step 1420.

### Emerging Issues Process

FIG. 15 is a flow chart describing an exemplary implementation of an emerging issues process 1500. Generally, the emerging issues process 1500 makes participants aware of the regulatory environment, the audits and inspections, including new developments and future trends in the field of clinical data management. As shown in FIG. 15, the emerging issues process 1500 addresses emerging issues in the pharmaceutical industry and their impact on data management during step 1510.

It is to be understood that the embodiments and variations shown and described herein are merely illustrative of the principles of this invention and that various modifications may be implemented by those skilled in the art without departing from the scope and spirit of the invention.

We claim:

1. A computer-based method for training a clinical data manager, said method comprising the steps of:
simulating clinical design aspects of a clinical trial;
simulating data collection aspects of a clinical trial;
simulating data recording aspects of a clinical trial;
simulating data validation aspects of a clinical trial; and
evaluating said clinical data manager on at least one of said simulating steps.

2. The method of claim 1, wherein said simulating steps are each performed by at least one different module.

3. The method of claim 1, wherein an output of one of said simulating steps that is subsequently used by a later step is validated and corrected before proceeding to said later step.

4. A computer-based method for training a clinical data manager to select a compound for a clinical trial from among a plurality of compounds that could be evaluated during a clinical trial, said method comprising the steps of:
providing information to said clinical data manager about a therapeutic area associated with said plurality of compounds;
providing information to clinical data manager about said plurality of compounds;
receiving a selection of one of said plurality of compounds from said clinical data manager; and
evaluating said selection relative to predefined criteria to determine if a correct compound is selected.

5. The method of claim 4, wherein said information about said therapeutic area includes marketing, demographic and current treatment information.

6. The method of claim 4, wherein said predefined criteria determines if said selected compound offers a greater possibility for drug development from among said plurality of compounds.

7. A computer-based method for training a clinical data manager, said method comprising the steps of:
providing a simulated clinical trial protocol to said clinical data manager, said simulated clinical trial protocol containing at least one error; and
providing at least one tool for said clinical data manager to analyze said clinical trial protocol to identify said at least one error.

8. The method of claim 7, further comprising the step of validating content contained in said clinical trial protocol.

9. A computer-based method for training a clinical data manager on the design of a Case Report Form used in a clinical trial, said method comprising the steps of:
providing a portion of a simulated Case Report Form to said clinical data manager;
presenting a list of potential variables to said clinical data manager;
receiving a selection from said clinical data manager of variables that should be included in said Case Report Form; and
evaluating said selection relative to predefined criteria.

10. The method of claim 9, wherein said predefined criteria considers whether said selection collects only data required by a protocol and avoids data redundancies.

11. A computer-based method for training a clinical data manager, said method comprising the steps of:
providing a simulated Case Report Form to said clinical data manager; and
providing at least one tool for said clinical data manager to design a portion of a simulated database to record data contained in said simulated Case Report Form.

12. The method of claim 11, further comprising the step of providing said clinical data manager with a complete database design.

13. The method of claim 11, further comprising the step of associating a number of data parameters with database tables.

14. A computer-based method for training a clinical data manager, said method comprising the steps of:
providing a simulated Case Report Form containing data to said clinical data manager;
providing one or more data entry screens to support entering said data into one or more databases; and
ensuring that each of the parameters in said simulated Case Report Form are included in said one or more databases.

15. The method of claim 14, further comprising the step of ensuring that each parameter in said simulated Case Report Form is properly mapped to said one or more databases.

16. The method of claim 14, further comprising the step of ensuring that possible values for each of said parameters are accurate.

17. A computer-based method for training a clinical data manager, said method comprising the steps of:
providing one or more databases associated with a simulated clinical trial to said clinical data manager, at least one of said databases containing at least one error; and
providing at least one tool for said clinical data manager to validate one or more databases to identify said at least one error.

18. The method of claim 17, wherein said at least one tool allows said clinical data manager to develop software code to validate data in said one or more databases.

19. The method of claim 18, wherein said software code validates data within one of said one or more databases.

20. The method of claim 18, wherein said software code validates data across said one or more databases.

21. The method of claim 18, wherein said software code is natural language constructs that identify said at least one error included in said data.

22. The method of claim 18, further comprising the step of receiving a data clarification request (DCR) from said clinical data manager.

23. The method of claim 17, wherein said validation ensures that data in said one or more databases is within a normal range.

24. The method of claim 17, wherein said validation ensures that each field in said one or more databases has been recorded

25. A computer-based method for training a clinical data manager, said method comprising the steps of:
presenting said clinical data manager with at least one adverse event to be coded;
presenting said clinical data manager with a list of body systems;
receiving a selection from said clinical data manager of a selected body system associated with said at least one adverse event;
presenting said clinical data manager with a list of subsystems associated with said selected body system;
receiving a selection from said clinical data manager of a selected subsystem, said selected subsystem having an associated set of potential adverse events; and
determining if said at least one adverse event to be coded is included in said associated set of potential adverse events.

26. A computer-based method for training a clinical data manager, said method comprising the steps of:
providing a simulated Case Report Form and a simulated serious adverse event database to said clinical data manager, said simulated Case Report Form containing at least one serious adverse event, said simulated Case Report Form and simulated serious adverse event database having at least one common field; and
receiving a selection from said clinical data manager of at least one common field that in said simulated Case Report Form and said simulated serious adverse event database that must be reconciled.

27. A computer-based method for training a clinical data manager, said method comprising the steps of:
providing one or more databases associated with a simulated clinical trial to said clinical data manager, at least one of said databases containing blind data;
providing simulated unbinding data to said clinical data manager, and
providing at least one tool for said clinical data manager to unblind said one or more databases to identify a treatment that was performed on a given participant in said clinical trial.
